(19) United States
(12) Patent Application Publication
(10) Pub. No.: US 2020/0394599 A1
(43) Pub. Date: Dec. 17, 2020

(54) SHELF-ALLOCATION INFORMATION GENERATING DEVICE AND SHELF-ALLOCATION INFORMATION GENERATING PROGRAM

(71) Applicant: NTT DOCOMO, INC., Chiyoda-ku (JP)

(72) Inventor: Hayato AKATSUKA, Chiyoda-ku (JP)

(73) Assignee: NTT DOCOMO, INC., Chiyoda-ku (JP)

(21) Appl. No.: 16/767,393

(22) PCT Filed: Nov. 14, 2018
(86) PCT No.: PCT/JP2018/042173

§ 371 Date: May 27, 2020

(30) Foreign Application Priority Data
Nov. 29, 2017 (JP) 2017-229343

(51) Int. Cl. G06Q 10/08; G06Q 10/10; G06Q 30/00; G06N 20/00; G06N 5/04; G06T 7/70; G06K 9/00

(52) U.S. Cl. CPC G06Q 10/087; G06Q 10/10; G06Q 30/0185; G06K 9/00671; G06N 5/04; G06T 7/70; G06N 20/00

(57) ABSTRACT

A planogram information generating device includes: an image acquiring unit that acquires an image acquired by imaging product display shelves; a detection unit that detects product area images representing the products from the image of the product display shelves; a product recognizing unit that recognizes products represented by the product area images on the basis of information relating to images of products stored in advance; a determination unit that determines validity of recognition of one product area image as a first product on the basis of relevancy information between the first product recognized as a product represented by the one product area image and one or more second products recognized as products represented by one or more other product area images other than the one product area image; and a correction unit that corrects the first product recognized as the product represented by the one product area image.

### TECHNICAL FIELD

The present invention relates to a planogram information generating device and a planogram information generating program.

### BACKGROUND ART

A technique in which products are recognized from an image acquired by imaging product display shelves and information on products arranged on each shelf known as planogram information is acquired is performed. For example, a technology for generating planogram information representing a product display state on the basis of a product recognized from an image including a product display shelf and information relating to a designated position of the product is known (for example, see Patent Literature 1).

### CITATION LIST

### Patent Literature

[Patent Literature 1] Japanese Unexamined Patent Publication No. 2016-224831

### SUMMARY OF INVENTION

### Technical Problem

However, in a conventional technology of generating planogram information, due to difficulty in distinguishably identifying products of the same series with very similar external views, products with different sizes, and the like through image recognition, the accuracy of recognition of a single product through image recognition is not sufficient. For this reason, in the conventional technology, it is difficult to acquire arrangement of products with high accuracy in the generation of planogram information, and it is desired to correctly recognize products arranged on a product display shelf.

The present invention is realized in consideration of the problems described above, and an object thereof is to provide a planogram information generating device and a planogram information generating program capable of easily performing improvement of accuracy of recognition of products through image recognition for an image of products included in an image of product display shelves and checking and correction of a result of the recognition in generation of planogram information that is arrangement information of products arranged on a product display shelf.

### Solution to Problem

In order to solve the problems described above, according to one embodiment of the present invention, there is provided a planogram information generating device that generates planogram information that is arrangement information of products arranged on product display shelves, the planogram information generating device including: an image acquiring unit that acquires an image acquired by imaging product display shelves on which a plurality of products are arranged; a detection unit that detects product area images representing the products from the image acquired by the image acquiring unit; a product recognizing unit that recognizes products represented by the product area images detected by the detection unit on the basis of information relating to images of products stored in advance; a determination unit that determines validity of recognition of one product area image as a first product on the basis of relevancy information between the first product recognized as a product represented by the one product area image and one or more second products recognized as products represented by one or more other product area images other than the one product area image; and a correction unit that corrects the first product recognized as the product represented by the one product area image by the product recognizing unit on the basis of information relating to the validity determined by the determination unit.

In addition, a planogram information generating program according to one embodiment of the present invention is a planogram information generating program causing a computer to function as a planogram information generating device that generates planogram information that is arrangement information of products arranged on product display shelves, the program causing the computer to realize: an image acquiring function of acquiring an image acquired by imaging product display shelves on which a plurality of products are arranged; a detection function of detecting product area images representing the products from the image acquired by the image acquiring function; a product recognizing function of recognizing products represented by the product area images detected by the detection function on the basis of information relating to images of products stored in advance; a determination function of determining validity of recognition of one product area image as a first product on the basis of relevancy information between the first product recognized as a product represented by the one product area image and one or more second products recognized as products represented by one or more other product area images other than the one product area image; and a correction function of correcting the first product recognized as the product represented by the one product area image by the product recognizing function on the basis of information relating to the validity determined by the determination function.

There is a feature in that the same products and products of the same category, the same manufacturer, and the same series/brand are arranged adjacently or closely in a product display shelf. In other words, one product arranged on a product display shelf has relevancy with other products adjacent to the one product and other products arranged within a predetermined distance from the one product. According to the embodiment described above, product area images are detected from an image of product display shelves, a product represented by each of the product area images is recognized, and validity of recognition of one product area image as a first product is determined on the basis of relevancy information between the first product recognized as a product represented by the one product area image and second products recognized as products represented by other product area images. Then, the first product recognized as the product represented by one product area image is corrected on the basis of information relating to the determined validity. In this way, a result of recognition of a product for a product area image is easily corrected, and the accuracy of the recognition can be improved.

### Advantageous Effects of Invention

A planogram information generating device and a planogram information generating program capable of easily performing improvement of accuracy of recognition of products through image recognition for an image of products included in an image of product display shelves and checking and correction of a result of the recognition in generation of planogram information that is arrangement information of products arranged on a product display shelf can be provided.

### BRIEF DESCRIPTION OF DRAWINGS

FIG. 1 is a block diagram illustrating the functional configuration of a planogram information generating device according to this embodiment.

FIG. 2 is a hardware block diagram of a planogram information generating device.

FIG. 3 is a diagram illustrating an example of an image of product display shelves acquired by an image acquiring unit.

FIG. 4 is a diagram illustrating detection of a product area image from an image of product display shelves.

FIG. 5 is a diagram schematically illustrating an example of product image data stored in a product data storing unit.

FIG. 6 is a diagram illustrating the configuration of a product master.

FIG. 7 is a diagram illustrating an example of planogram data acquired by a planogram analyzing unit.

FIG. 8 is a diagram illustrating an example of acquisition of relevancy information relating to one product area image.

FIG. 9 is a diagram illustrating another example of acquisition of relevancy information relating to one product area image.

FIG. 10 is a diagram illustrating a process of generating a feature quantity and determining validity using a determination unit.

FIG. 11 is a diagram illustrating another example of a process of generating a feature quantity and determination of validity using a determination unit.

FIG. 12 is a diagram illustrating another example of a process of generating a feature quantity and determination of validity using a determination unit.

FIG. 13 is a diagram illustrating an example of display of information relating to validity.

FIG. 14 is a diagram illustrating another example of display of information relating to validity.

FIG. 15 is a diagram illustrating another example of display of information relating to validity.

FIG. 16 is a flowchart illustrating process details of a planogram information generating method according to this embodiment.

FIG. 17 is a diagram illustrating the configuration of a planogram information generating program.

### DESCRIPTION OF EMBODIMENTS

A planogram information generating device according to an embodiment of the present invention will be described with reference to the drawings. If applicable, the same reference signs will be assigned to the same parts, and duplicate description thereof will be omitted.

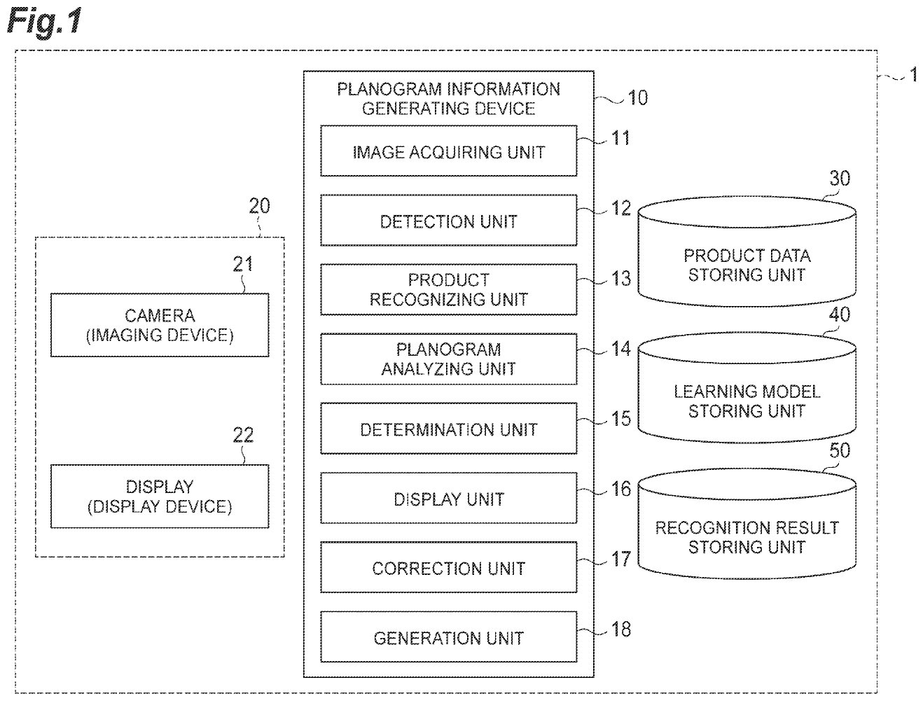

FIG. 1 is a diagram illustrating the functional configuration of a planogram information generating system 1 including a planogram information generating device 10 according to this embodiment. The planogram information generating device 10 is a device that generates planogram information that is arrangement information of products arranged on a product display shelf and includes a configuration for easily performing checking and correction of a result of recognition of an image of products of product display shelves.

As illustrated in FIG. 1, the planogram information generating system 1 includes the planogram information generating device 10, an imaging/display device 20, a product data storing unit 30, a learning model storing unit 40, and a recognition result storing unit 50.

The planogram information generating system 1 may be configured as one device, or one or a plurality of planogram information generating devices 10, imaging/display devices 20, product data storing units 30, learning model storing units 40, and recognition result storing units 50 may configure respective devices. As one example, the imaging/display device 20 is configured as one terminal, and the planogram information generating device 10, the product data storing unit 30, the learning model storing unit 40, and the recognition result storing unit 50 may be configured by a server. In addition, as another example, the planogram information generating device 10 and the imaging/display device 20 may be configured as one terminal. Each of the product data storing unit 30, the learning model storing unit 40, and the recognition result storing unit 50 may be configured by devices of any aspect as long as the devices are configured to be accessible from the planogram information generating device 10. In a case in which the imaging/display device 20 is configured as one terminal, an imaging person can check whether there is an error in the planogram information generated through image recognition by referring to a display screen while imaging product display shelves. In addition, in the example of a terminal configured by only a display (display device) 22, an operator or the like is assumed to perform an operation of checking and correcting planogram information generated through image recognition at an office or the like rather than an actual store.

In this embodiment, a terminal configuring the imaging/display device 20 or a terminal configuring the planogram information generating device 10 and the imaging/display device 20, for example, is configured as a mobile terminal such as a high-function cellular phone (smartphone) or a cellular phone.

As illustrated in FIG. 1, the planogram information generating device 10 functionally includes an image acquiring unit 11, a detection unit 12, a product recognizing unit 13, a planogram analyzing unit 14, a determination unit 15, a display unit 16, a correction unit 17, and a generation unit 18. In addition, the imaging/display device 20 includes a camera 21 as an imaging device and a display 22 as a display device. Such functional units will be described later in detail.

The block diagram illustrated in FIG. 1 illustrates blocks in units of functions. Such functional blocks (components) are realized by an arbitrary combination of hardware and/or software. In addition, a means that realizes each functional block is not particularly limited. In other words, each functional block may be realized by one device that is combined physically and/or logically or may be realized by directly and/or indirectly (for example, in a wired manner and/or a wireless manner) connecting two or more devices that are separated physically and/or logically and using the plurality of devices.

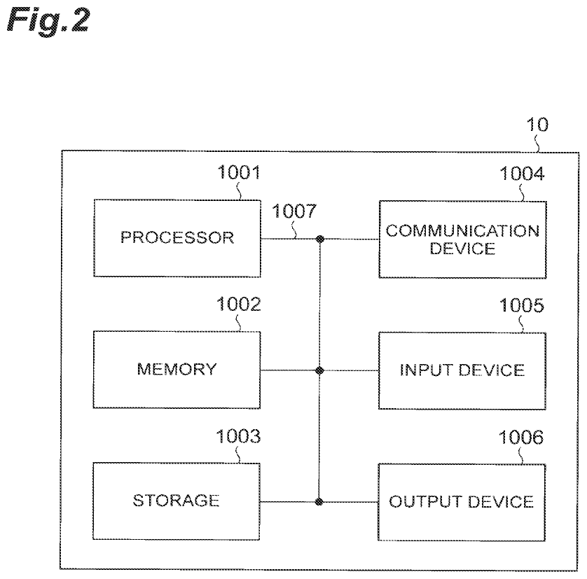

For example, the planogram information generating device 10 according to one embodiment of the present invention may function as a computer. FIG. 2 is a diagram illustrating one example of the hardware configuration of the planogram information generating device 10 according to this embodiment. The planogram information generating device 10 may be physically configured as a computer device including a processor 1001, a memory 1002, a storage 1003, a communication device 1004, an input device 1005, an output device 1006, a bus 1007, and the like.

In addition, in the following description, the term “device” may also refer to a circuit, a device, a unit, or the like. The hardware configuration of the planogram information generating device 10 may be configured to include one or a plurality of devices illustrated in FIG. 2 or may be configured not to include some of the devices.

Each function of the planogram information generating device 10 is realized by the processor 1001 performing an arithmetic operation and controlling communication using the communication device 1004 and data reading and/or writing for the memory 1002 and the storage 1003 by causing the processor 1001 to read predetermined software (a program) onto hardware such as the memory 1002 or the like.

The processor 1001, for example, controls the entire computer by operating an operating system. The processor 1001 may be configured by a central processing unit (CPU) including an interface with peripheral devices, a control device, an arithmetic operation device, a register, and the like. In addition, the processor 1001 may be configured to include a graphics processing unit (GPU). For example, functional units 11 to 18 illustrated in FIG. 1 and the like may be realized by the processor 1001.

In addition, the processor 1001 reads a program (program code), a software module, and data from the storage 1003 and/or the communication device 1004 into the memory 1002 and executes various processes in accordance with this. As the program, a program causing the computer to execute at least some of the operations described in the embodiment described above is used. For example, the functional units 11 to 13 of the planogram information generating device 10 may be realized by a control program that is stored in the memory 1002 and is operated by the processor 1001. While various processes described above have been described as being executed by one processor 1001, the processes may be executed by two or more processors 1001 simultaneously or sequentially. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like that can be executed to perform a planogram information generating method according to one embodiment of the present invention.

The storage 1003 is a computer-readable recording medium and, for example, may be configured by at least one of an optical disc such as a compact disc ROM (CD-ROM), a hard disk drive, a flexible disk, a magneto-optical disc (for example, a compact disc, a digital versatile disc, or a Blue-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including the memory 1002 and/or storage 1003, a server, or any other appropriate medium.

The communication device 1004 is hardware (a transmission/reception device) for performing inter-computer communication through a wired and/or wireless network and, for example, may also be called a network device, a network controller, a network card, a communication module, or the like.

The input device 1005 is an input device (for example, a keyboard, a mouse, a microphone, a switch, a button, a sensor, or the like) accepting an input from the outside. The output device 1006 is an output device (for example, a display, a speaker, an LED lamp, or the like) performing output to the outside. In addition, the input device 1005 and the output device 1006 may have an integrated configuration (for example, a touch panel).

In addition, devices such as the processor 1001, the memory 1002, and the like are interconnected through a bus 1007 for communication of information. The bus 1007 may be configured as a single bus or may be configured using different buses for different devices.

In addition, the planogram information generating device 10 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by hardware. For example, the processor 1001 may be realized using at least one of such hardware components.

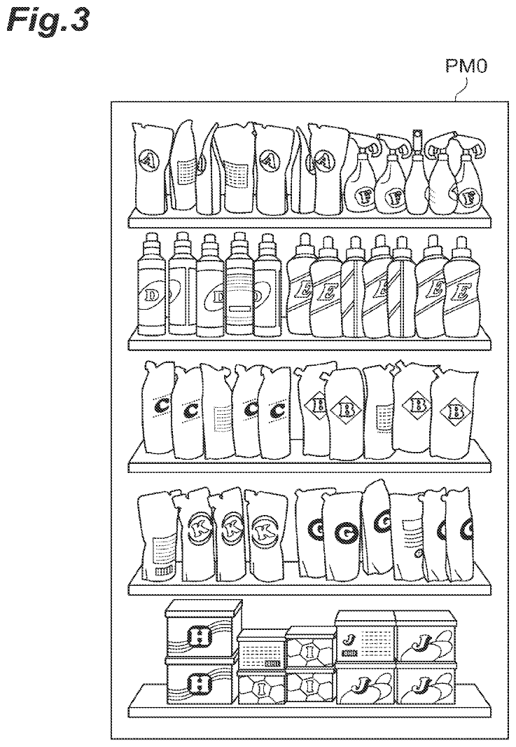

Referring back to FIG. 1 again, each functional unit of the planogram information generating device 10 will be described. The image acquiring unit 11 acquires an image acquired by imaging product display shelves on which a plurality of products are arranged. FIG. 3 is a diagram illustrating an example of an image PM0 of product display shelves acquired by the image acquiring unit 11. More specifically, when product display shelves are imaged by the camera 21, the image acquiring unit 11 acquires an image that is imaged by the camera 21 as an image of product display shelves. As illustrated in FIG. 3, the image PM0 of the product display shelves includes product display shelves and a plurality of products arranged on each shelf.

The product display shelves and the products arranged on the product display shelves, as illustrated in FIG. 3 as an example, have features as described below. In other words, there is a feature in that the same products are arranged adjacently or closely. Particularly, in a large store or the like, a plurality of units are arranged for each product, and thus, this feature markedly appears. On the other hand, in a medium/small store or the like, there are many cases in which one unit is arranged for each product, and this feature is unlikely to appear. The number of units arranged for each product is represented by the word “face.” In other words, the number of faces of the same product is large, and there are a sufficient arrangement space in a large store, and the number of faces of the same product is small in a small store.

In addition, there is a feature in that products belonging to the same series and products belonging to the same brand are arranged at positions close to each other on a product display shelf. In addition, there is a feature in that products belonging to the same manufacturer or products belonging to the same category are arranged at positions close to each other on product display shelves or are arranged on the same product display shelf.

In consideration of the features of product display shelves and arranged products described above, the planogram information generating device 10 according this embodiment determines the validity of a result of recognition of products relating to one product area image using results of recognition of other product area images positioned on the vicinity of the one product area image and products relating to the other product area images.

The detection unit 12 detects a product area image representing products from an image of product display shelves acquired by the image acquiring unit 11. More specifically, the detection unit 12, for example, recognizes each object extracted using a technique such as a known edge detection technique or the like for an image of product display shelves as a product area image representing products. In addition, the detection unit 12, for example, has learned a shape of each product in advance using a technique of known deep learning or the like and detects a product area image representing products from the image of product display shelves using learned data. Furthermore, the shape data of products learned in advance may be stored in the learning model storing unit 40. The learning model storing unit 40 will be described later in detail. The technique used for detection of a product area image from an image of product display shelves is not limited to the example described above, and any technique may be used as long as it enables detection of each product area image.

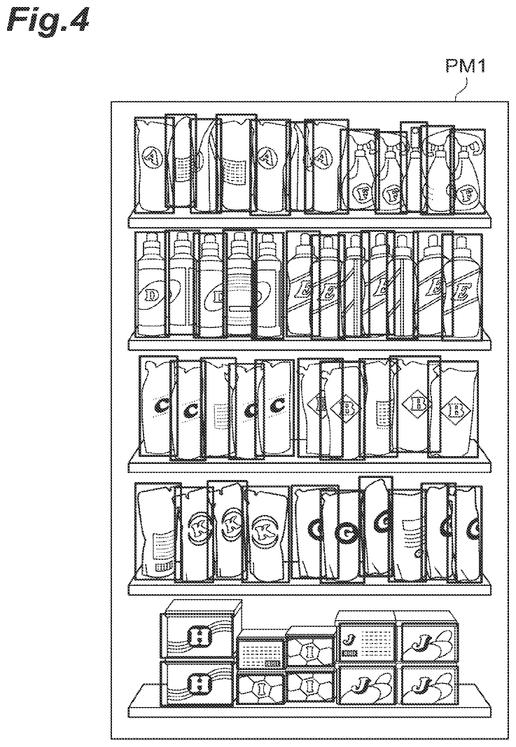

FIG. 4 is a diagram illustrating detection of product area images from an image PM1 of product display shelves. As illustrated in FIG. 4, the detection unit 12 detects a plurality of product area images each representing a product from the image PM1 of product display shelves, and a grid line corresponding to an outer frame of each product area image is attached in a detected product area image.

The product recognizing unit 13 recognizes a product represented by a product area image detected by the detection unit 12 on the basis of information relating to images of products stored in advance. In this embodiment, the information relating to images of products used for recognition of products is stored in the product data storing unit 30.

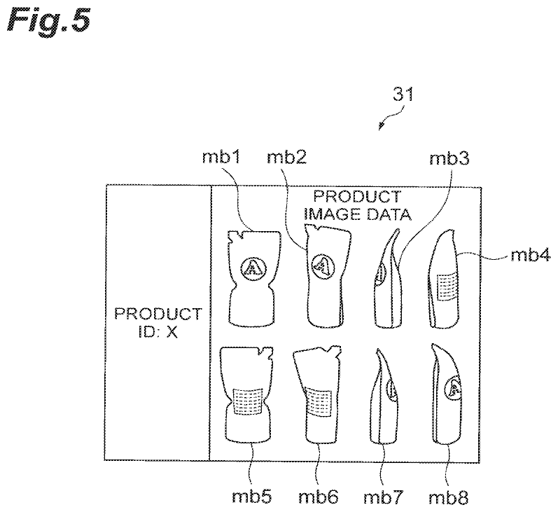

FIG. 5 is a diagram schematically illustrates an example of product image data 31 stored in the product data storing unit 30. As illustrated in FIG. 5, the product image data 31 stores a plurality of pieces of product image data mb1 to mb8 representing outer views of products in association with product IDs used for identifying products. The product image data mb1 to mb8 represents outer views of a product identified by a product ID: X in various directions. In addition, product image data stored in the product data storing unit 30 is not limited to the example illustrated in FIG. 5, and the product data storing unit 30 may include one piece of product image data for each product ID or may include image data representing outer views in a case in which a product is gradually rotated in a vertical direction in addition to image data representing outer views in a case in which the product is gradually rotated in a horizontal direction as illustrated in the example illustrated in FIG. 5. Furthermore, the product data storing unit 30 may include one of one piece of product image data representing a front outer view of a product, one piece of product image data representing a rear outer view of the product, and a plurality of pieces of product image data acquired by imaging the product in a plurality of directions in association with each product ID and may include a combination of such product image data in association with each product ID.

The product recognizing unit 13 collates product image data mb stored in the product data storing unit 30 with each product area image detected by the detection unit 12 using a known collation technology and accordingly can recognize a product represented by the product area image. In addition, recognition of a product is not limited to the collation technology described above and the like, and any technique may be used. For example, the product recognizing unit 13 may learn outer views of various products in advance using a technique of deep leaning or the like and recognize a product represented by each product area image.

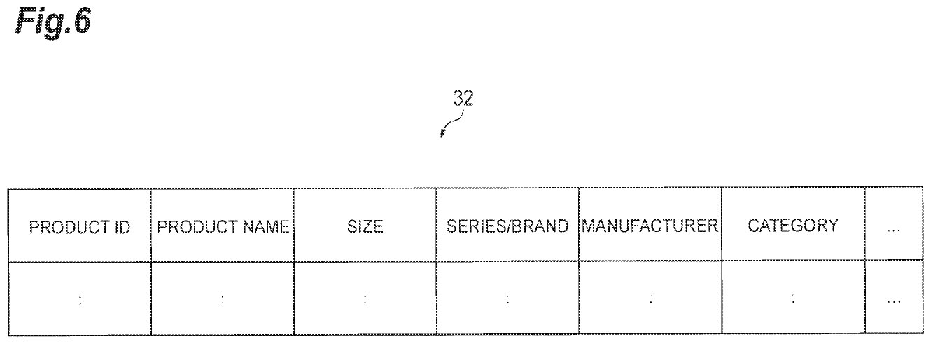

In this embodiment, the product data storing unit 30 stores a product master 32 that includes various attributes of products. FIG. 6 is a diagram illustrating the configuration of the product master 32. As illustrated in FIG. 6, the product master 32 stores a product name, a size, a series/brand, a manufacturer, a category, and the like of a product in association with a product ID used for identifying the product. In addition, product attributes associated with each product are not limited to those of the example illustrated in FIG. 6, and more sub-divided attributes may be included. Since a product represented by the product area image is recognized by the product recognizing unit 13, each product area image can be associated with attributes of a product by referring to the product master 32 using the product ID of the recognized product as a key.

The product recognizing unit 13 stores a result of recognition of a product for each product area image in the recognition result storing unit 50. The recognition result storing unit 50 is a storage means that stores a product area image and a product recognized in relation to the product area image in association with each other.

The planogram analyzing unit 14 acquires planogram data that is information relating to arrangement of products on each of product display shelves on the basis of a result of recognition of a product acquired by the product recognizing unit 13 and a positional relation of a product area image in an image of product display shelves.

More specifically, first, the planogram analyzing unit 14 recognizes the position of a shelf board from an image of product display shelves. Since products are arranged on a shelf board, for example, the planogram analyzing unit 14 acquires a distribution of pixels, which represent a product area image for each coordinate of a coordinate axis extending in the vertical direction, of an image of product display shelves and acquires coordinate values at which the pixel distribution is smaller than a predetermined value, an area near a minimal point of the pixel distribution, and the like as positions of the shelf board in the vertical direction.

In addition, the planogram analyzing unit 14 may learn images of shelf boards, images of price tags attached to shelf boards, and the like in advance in addition to images representing products and acquire positions of shelf boards using a known collation technology or a technique of deep learning or the like.

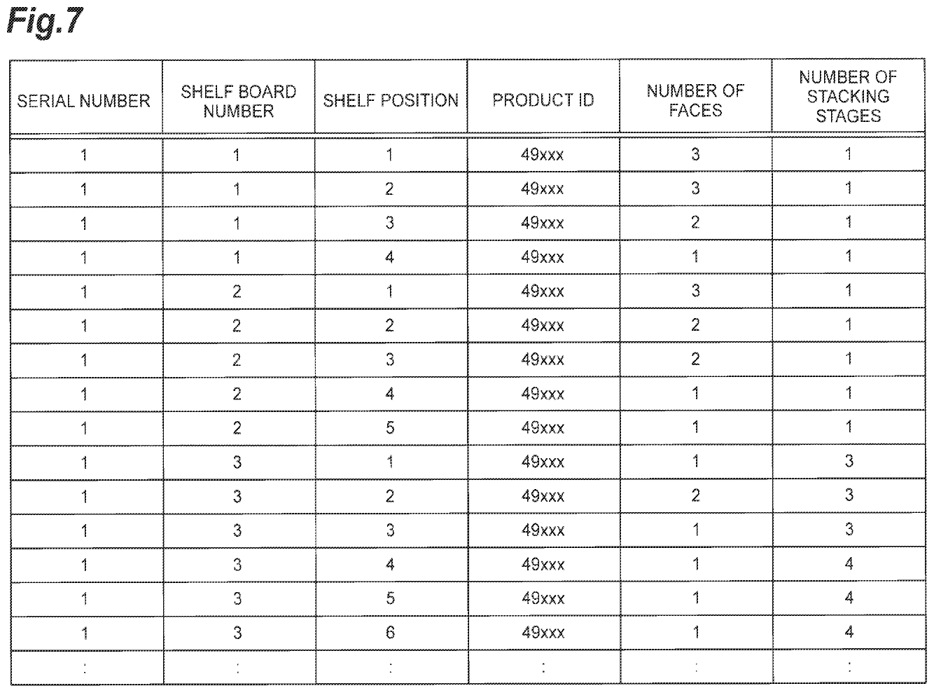

Then, the planogram analyzing unit 14 acquires planogram data on the basis of a positional relation between the position of a shelf board acquired from the image of product display shelves and the position of a product area image detected by the detection unit and information of products represented by a product area image recognized by the product recognizing unit 13. FIG. 7 is a diagram illustrating an example of planogram data acquired by the planogram analyzing unit 14. As illustrated in FIG. 7, the planogram data includes information of a serial number, a shelf board number, a shelf position, a product ID, the number of faces, and the number of stacking stages in association with each other. The serial number is information used for identifying a product display shelf. The shelf board number is information used for identifying a shelf board in a product display shelf and, for example, numbers are assigned from a lower stage to an upper stage. The shelf position is information used for identifying a position of one shelf board in the horizontal direction, and, for example, numbers are assigned from the left side to the right side in a product display shelf image. The product ID is information used for identifying a product. The number of faces is the number of arranged products of the same kind. The number of stacking stages is the number of products of the same kind stacked at a certain position on a shelf board.

The determination unit 15 determines validity of recognition of one product area image as a first product on the basis of relevancy information between the first product recognized as a product represented by one product area image and one or more second products recognized as products represented by one or more other product area images other than the one product area image.

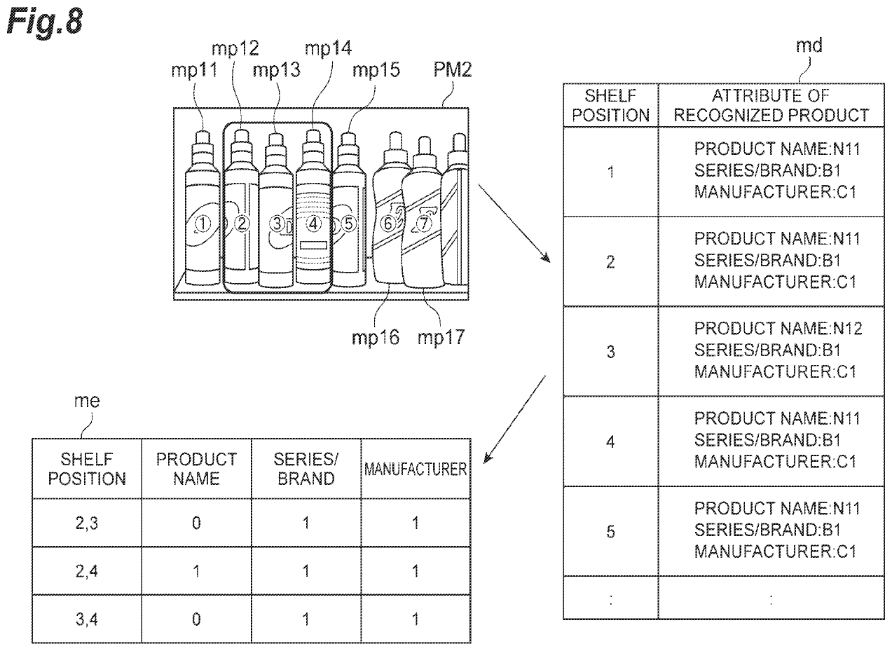

An example of the relevancy information will be described with reference to FIG. 8. FIG. 8 is a diagram illustrating an example of acquisition of relevancy information relating to one product area image. As illustrated in FIG. 8, an image PM2 of a product display shelf includes product area images mp11 to mp17 of products arranged at shelf positions 1 to 7 on a certain shelf. A reference sign and represents information of attributes of recognized products in relation to the product area images mp11 to mp17 of products arranged at the shelf positions 1 to 7. For example, a product recognized in relation to a product area image of a product arranged at the shelf position 1 has attributes of a product name: N11, a series/brand: B1, and a manufacturer C1.

Here, an example in which relevancy information for a product area image mp13 of a product arranged at the shelf position 3 is acquired is illustrated. In this example, the determination unit 15 acquires relevancy information me representing relevance between a product (first product) recognized as a product represented by the product area image mp13 and products (second products) recognized as products represented by product area images mp12 and mp14 adjacent to the product area image mp13 on the basis of attribute information of each product represented by a reference sign md.

In the relevancy information me illustrated in FIG. 8, data representing same/difference in the product name, the series/brand, and the manufacturer between products of the shelf positions 2, 3, and 4 (in the case of being different: 0, in the case of being the same: 1) are included as elements. More specifically, between products that are recognized as products represented by the product area image mp12 of the shelf position 2 and the product area image mp13 of the shelf position 3, the product names are different, and the series/brands and the manufacturers are the same, and the determination unit 15 generates relevancy information me of which data representing such same/difference is “0, 1, 1”. Similarly, between products that are recognized as products represented by the product area image mp12 of the shelf position 2 and the product area image mp14 of the shelf position 4, the product names, the series/brands, and the manufacturers are the same, and the determination unit 15 generates relevancy information me of which data representing such same/difference is “1, 1, 1”. In addition, between products that are recognized as products represented by the product area image mp13 of the shelf position 3 and the product area image mp14 of the shelf position 4, the product names are different, and the series/brands and the manufacturers are the same, and the determination unit 15 generates relevancy information me of which data representing such same/difference is “0, 1, 1”.

In addition, although the same/difference of attributes such as the product names, the manufacturers, and the like are represented using binary values of “1” and “2” in the relevancy information illustrated in FIG. 8, this is merely one example, and, for example, the degree of coincidence of the attributes may be represented using a numerical value in the range of 0 to 1 or may be represented using any other range of numerical values.

In addition, in the example illustrated in FIG. 8, although products adjacent on both sides are focused when relevancy information relating to one product area image is generated, not only the products adjacent on both the sides (products of which the number of faces from one product area image is within “1”), products arranged within the number of faces that is two or more in each of the rightward direction and the leftward direction may be focused, and more product area images in the vicinity of one product area image may be included to be focused.

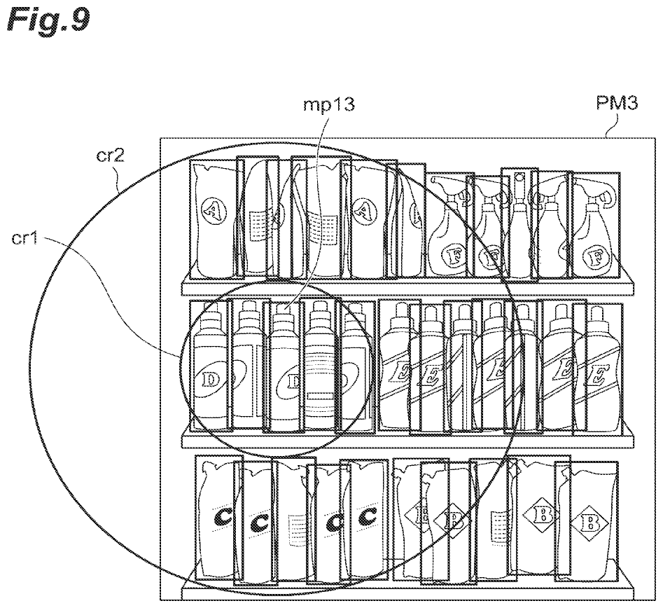

Other product area images focused for generating relevancy information relating to one product area image may include product area images present within a predetermined distance from one product area image in an image of a product display shelf. FIG. 9 is a diagram illustrating another example of acquisition of relevancy information relating to one product area image.

As illustrated in an image PM3 of a product display shelf illustrated in FIG. 9, when relevancy information relating to the product area image mp13 is generated, the determination unit 15 may generate the relevancy information with product area images included in a range cr1 within a predetermined distance from the product area image mp13 focused. In addition, the determination unit 15 may generate relevancy information with product area images included in a range cr2 within a distance that is further long from the product area image mp13 focused. A distance from one product area image to another product area image may be counted using the number of pixels in an image of product display shelves or may be counted using the number of faces in a case in which planogram data is acquired.

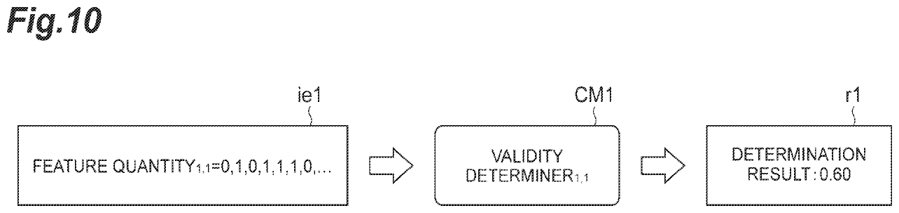

Subsequently, the determination unit 15 generates a feature quantity relating to one product area image on the basis of relevancy information and determines validity of a result of recognition of a product relating to one product area image on the basis of the generated feature quantity. FIG. 10 is a diagram illustrating a process of generation of a feature quantity and determination of validity using the determination unit 15.

In this embodiment, for example, the determination unit 15 generates a feature quantity relating to one product area image mp13 on the basis of the relevancy information me illustrated in FIG. 8. More specifically, the determination unit 15 generates a feature quantity ie1 as below by using values representing same/difference of product names, series/brands, and manufacturers represented in the relevancy information me as values (feature) of each item.

Feature quantity ie1=(0,1,0,1,1,1,1,1,1) (1)

In addition, the feature quantity represented in Equation (1) is one example of a case in which a validity determiner using a linear learner is used for denervation of validity, and a feature quantity and the relevancy information used for generation of the feature quantity are not limited to those of this example. The feature quantity described above is merely one example, is information on which relevancy between a product recognized as a product represented by one product area image and a product recognized as a product represented by a product area image that is adjacent or close to the one product area image or within a predetermined distance is reflected, and may be any information as long as the information has a form that is appropriate for being used by a predetermined learner and a determiner. As will be described later, the learner and the determiner are not limited to the case of being configured by a linear learner, and a known technology of linear learning, a SVM, a neural network, or the like may be employed.

As illustrated in FIG. 10, the determination unit 15 inputs the generated feature quantity ie1 to a validity determiner CM1 and acquires a result r1 (validity score) of determination of validity of recognition of a product relating to one product area image. The validity determiner CM1 is a machine-learned determiner relating to determination of validity based on a predetermined feature quantity.

For example, in the example of this embodiment, in a case in which the validity determiner CM1 is configured as a linear learner, a validity score y of a result of determination of validity having a feature quantity ie1 as a feature vector x having the number of features as the number of items is calculated using the following Equation (2).

$$y = f ( \vec{w} • \vec{x} ) = f ( {\sum }_{j} {w}_{j} {x}_{j} ) \qquad ( 2 )$$

Here, elements of the feature vector x is represented as below on the basis of a feature quantity ie1.

x1=0,x2=1,x3=0,x4=1,x5=1,x6=1, . . .

In addition, a vector w is a vector that is used for weighting a feature quantity and is acquired for determining validity based on the feature quantity through machine learning in advance.

While a value of the validity score y that is a result of the determination is different in accordance with details to be learned, for example, the value takes a value in the range of 0 to 1, and it can be learned such that the validity is the highest when y=1, and the validity is the lowest when y=0.

Since the relevancy information me illustrated in FIG. 8 focuses on relevancy with product area images adjacent on the left and right sides of one product area image, the validity determiner CM1 for a feature quantity ie1 based on the relevancy information me illustrated in FIG. 10 is configured through machine learning based on a feature quantity generated with relevancy between a product area image relating to determination of validity and product area images adjacent on the left and right sides thereof focused.

As described above, when relevancy information relating to one product area image is generated, focused product area images are not limited to product area images adjacent on the left and right sides of the one product area image, and accordingly, the validity determiner provided for determination of validity is configured through machine learning according to product area images focused when relevancy information is generated.

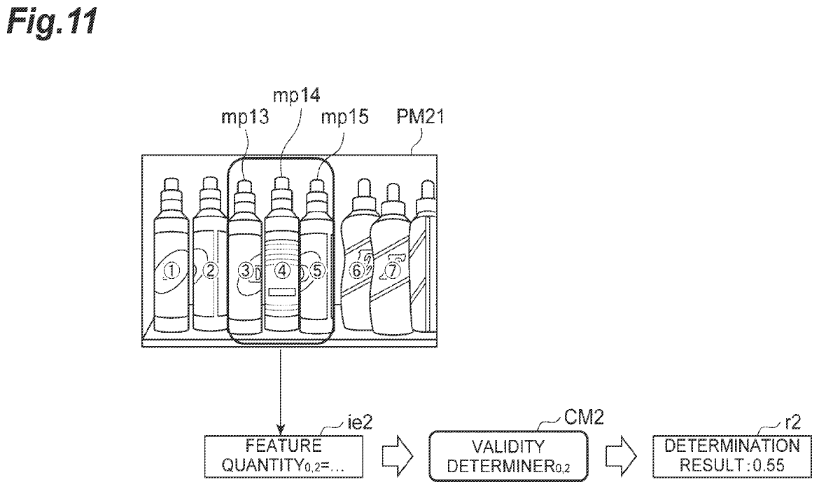

FIG. 11 is a diagram illustrating another example of the process of generating a feature quantity and determining validity using the determination unit 15. In the example illustrated in FIG. 11, when the validity of recognition of a product relating to one product area image mp13 is determined, relevancy information generated using two product area images mp14 and mp15 arranged to the right side of the product area image mp13 as targets is used. The determination unit 15 generates relevancy information representing relevancy between a product recognized for the product area image mp13 and products recognized for the product area images mp14 and mp15 and generates a feature quantity on the basis of the generated relevancy information ie2.

A validity determiner CM2 used here is different from the validity determiner CM1 illustrated in FIG. 10. In other words, the validity determiner CM2 is configured through machine learning based on a feature quantity generated with relevancy between a product area image relating to determination of validity and two product area images arranged to the right side thereof focused. Then, the determination unit 15 inputs the feature quantity ie2 to the validity determiner CM2 and acquires a result r2 (validity score) of determination of validity of recognition of a product relating to the one product area image mp13.

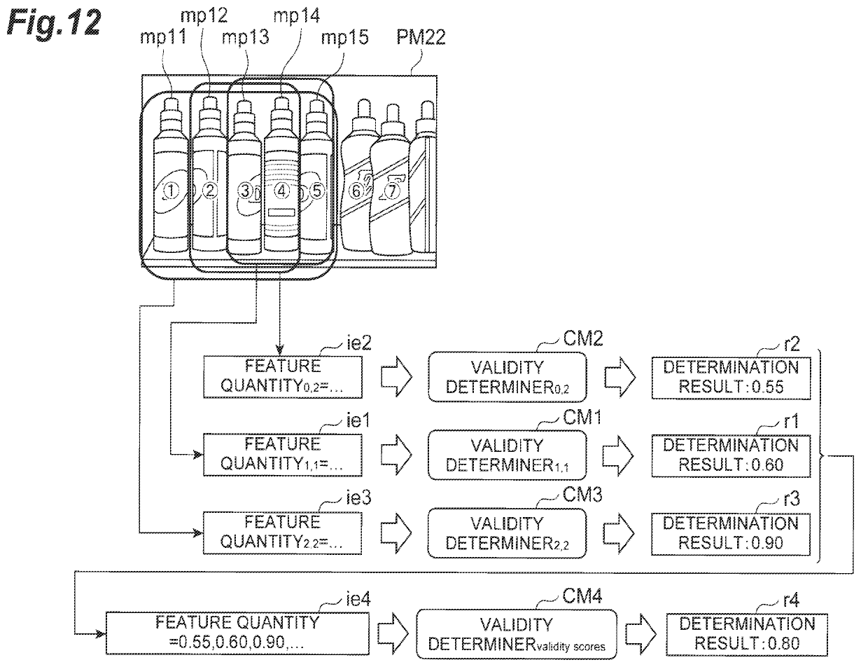

FIG. 12 is a diagram illustrating another example of the process of generating a feature quantity and determining validity using the determination unit 15. In addition to the determination of validity (calculation of a validity score) described with reference to FIGS. 10 and 11, in the example illustrated in FIG. 12, when the validity of recognition of a product relating to one product area image mp13 is determined, relevancy information generated for product area images mp11, mp12, mp14, and mp15 that are respective two areas arranged on each of both left and right sides of the product area image mp13 as targets is used. The determination unit 15 generates relevancy information representing relevancy between a product recognized for the product area image mp13 and products recognized for the product area images mp11, mp12, mp14, and mp15 and generates a feature quantity ie3 on the basis of the generated relevancy information. Then, the determination unit 15 inputs the feature quantity ie2 to the validity determiner CM3 and acquires a result r3 (validity score) of determination of validity of recognition of the product for the one product area image mp13. The validity determiner CM3 is configured through machine learning based on a feature quantity generated with relevancy between a product area image relating to determination of validity and two respective product area images arranged on both left and right sides thereof focused.

In addition, the determination unit 15 may generate a feature quantity ie4 originated from the determination results r1 to r3 output by a plurality of validity determiners CM1 to CM3, acquire a determination result r4 by inputting the generated feature quantity ie4 to a validity determiner CM4, and determine validity of recognition of the product relating to the product area image mp13. The validity determiner CM4 used here is configured on the basis of machine learning having results of determination of validity (validity scores) of predetermined three types relating to a product area image relating to determination of validity as a feature quantity.

In addition, in the examples illustrated in FIGS. 10 to 12, although a case in which the validity determiner is configured by a linear learner has been described, the validity determiner is not limited thereto and may be configured or using a known technology of a non-linear learner, a support vector machine (SVM), a neural network, or the like.

The learning model storing unit 40 illustrated in FIG. 1 is a storage means that stores a learning model that is a result of machine learning in the validity determiner CM illustrated in FIGS. 10 to 12, and the determination unit 15 acquires an appropriate learning model according to the configuration of the feature quantity by referring to the learning model storing unit 40 and calculates a validity score.

The display unit 16 displays information relating to the validity determined by the determination unit 15. More specifically, the display unit 16 displays information relating to validity relating to recognition of a product for a product area image on a display 22. In addition, the display unit 16 is not an essential component of the planogram information generating device 10 according to this embodiment.

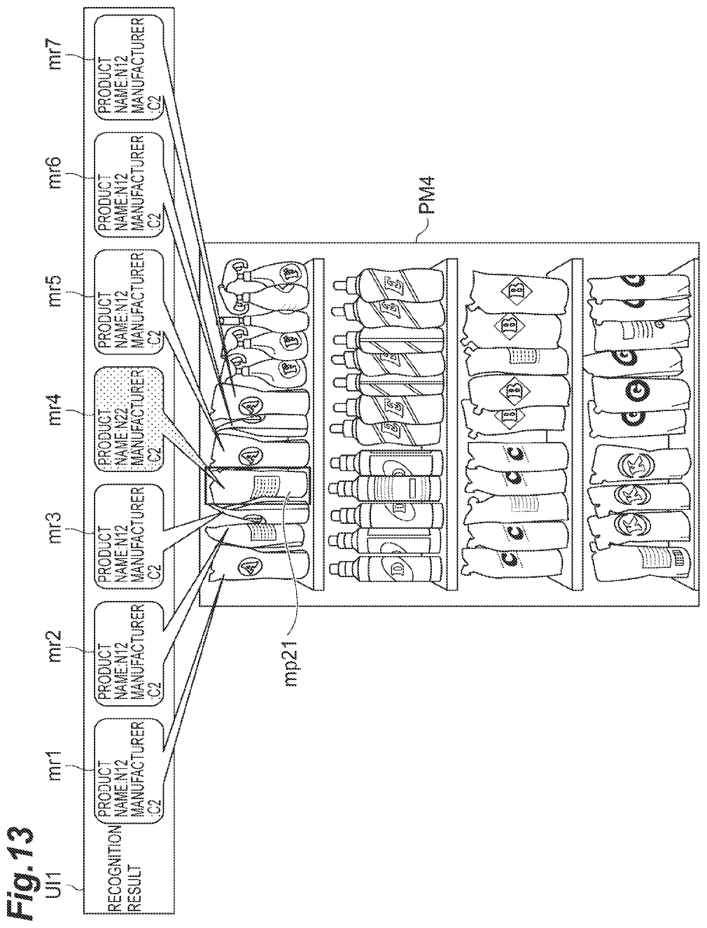

FIG. 13 is a diagram illustrating an example of display of information relating to validity. In a case in which the validity of recognition of one product area image determined by the determination unit 15 is less than a predetermined degree, the display unit 16 displays information relating to the validity in a predetermined form in association with the one product area image.

As illustrated in FIG. 13, the display unit 16 displays an image of product display shelves PM4 on the display 22 and displays information UI1 relating to recognition results of products for product area images and validity of the recognition on the display 22.

The information UI1, for example, includes recognition results mr1 to mr7 for some of product area images of a product display shelf of the fourth stage (uppermost stage). The recognition results mr1 to mr7 include product names and manufacturers that are some of attributes of the recognized products and, for example, illustrates shapes of a blow-off type and are respectively associated with product area images.

The example illustrated in FIG. 13 illustrates a case in which the validity of recognition (for example, a validity score) of a product for a product area image mp21 is less than a predetermined degree. As illustrated in FIG. 13, the display unit 16 displays the recognition result mr4 of a product for a product area image mp21 in association with the product area image mp21. In the example illustrated in FIG. 13, the product area image mp21 represents a product having a product name: N21 and a manufacturer: C2. On the other hand, a product represented by the product area image mp21 is recognized by the product recognizing unit 13 as a product having a product name: N22 and a manufacturer: C2. For this reason, it is determined that the validity of recognition of a product for the product area image mp21 using the determination unit 15 is low. Accordingly, the display unit 16 displays the recognition result mr4 in a form emphasized by applying a color or the like thereto. In this way, a product area image for which the validity of the result of recognition of a product is low can be recognized by a user.

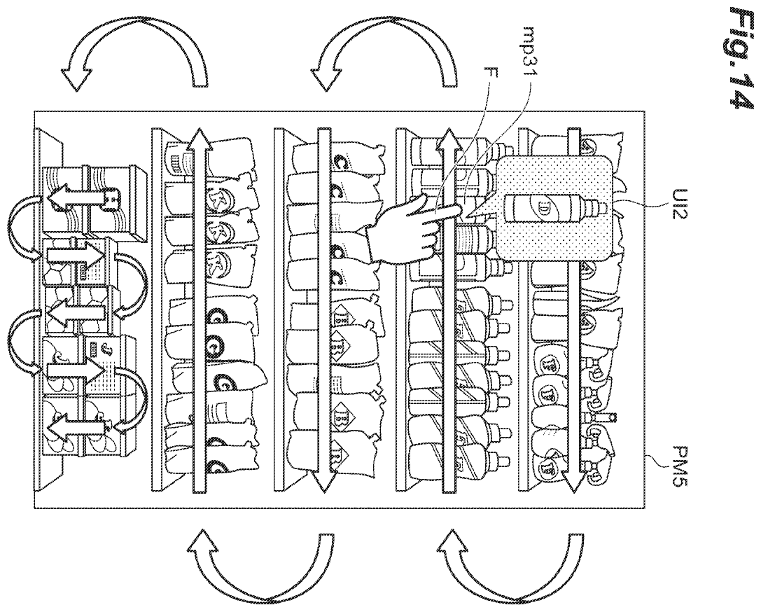

FIG. 14 is a diagram illustrating another example of display of information relating to validity. As illustrated in FIG. 14, the display unit 16 displays an image PM5 of a product display shelf on the display 22 and displays information UI2 relating to a recognition result of a product for a product area image and validity of recognition on the display 22.

In the example illustrated in FIG. 14, more specifically, by touching a product area image represented in an image PM5 of a product display shelf using a user's finger F, the display unit 16 displays information of a product recognized for each product area image (an outer view image of a product in the example illustrated in FIG. 14) in association with each product area image. In this way, a user can compare a recognition result of each product area image with the product area image, and accordingly, a result of recognition of an image of a product can be easily checked and corrected. In addition, in a case in which the validity of recognition of a product for the product area image mp31 is less than a predetermined degree, the display unit 16, as illustrated in information UI2, displays an outer view image representing a result of recognition of the product for the product area image mp31 in a form emphasized by applying a color or the like thereto. In this way, a user can recognize a product area image for which validity of a result of product recognition is low.

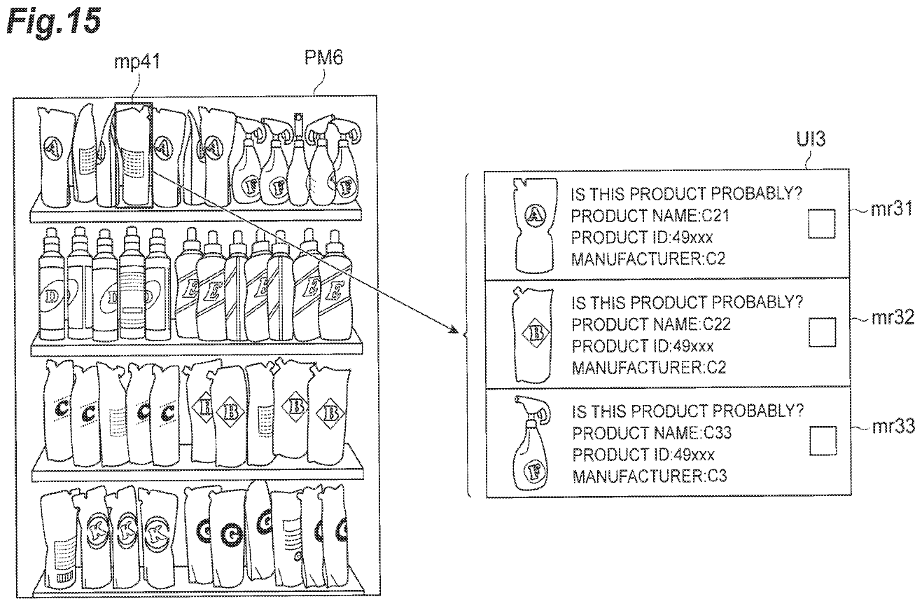

FIG. 15 is a diagram illustrating another example of display of information relating to validity. As illustrated in FIG. 15, the display unit 16 displays an image PM6 of a product display shelf on the display 22 and displays information UI3 relating to a result of recognition of a product relating to a product area image and validity of the recognition on the display 22.

In this example, the product recognizing unit 13 recognizes a plurality of candidates for a product represented by one product area image for the one product area image. For example, as illustrated in FIG. 15, the product recognizing unit 13 outputs three products (product names: C21, C22, and C33) in order of highest to lowest score representing the reliability of product recognition as a result of recognition of one product area image mp41. Here, it is assumed that scores representing reliability of image recognition are higher in order of a product having the product name C22, a product having the product name C33, and a product having the product name C21.

The determination unit 15 determines validity of recognition for each of a plurality of products output by the product recognizing unit 13 as a result of recognition of one product area image. Then, the display unit 16 displays at least one product candidate among a plurality of product candidates and information relating to validity thereof in association with one product area image.

For example, the display unit 16 may sort information of a plurality of products recognized by the product recognizing unit 13 in order of highest to lowest validity of the recognition result of a product and displays the sorted information. Here, it is assumed that the validity of a recognition result for products is higher in order of the product having the product name C21, the product having the product name C22, and the product having the product name C33. As illustrated in FIG. 15, the display unit 16 displays product information mr31 of the product name C21, product information mr32 of the product name C22, and product information mr33 of the product name C33 in order of highest to lowest validity of recognition result for products as information relating to validity of product recognition for the product area image mp41.

In the example illustrated in FIG. 15, each of pieces of the product information mr31 to mr32 includes a check box. When a user inputs a check mark in a check box of a correct product as a result of recognition of the product area image mp41, the product recognizing unit 13 can store the product to which the check mark has been input in the recognition result storing unit 50 as a result of recognition of the product area image mp41. In this way, a result of recognition of a product for one product area image can be easily checked and corrected.

In addition, instead of displaying information of a plurality of products as illustrated in FIG. 15, the display unit 16 may display only a candidate for a product of which the validity of a recognition result of the product determined by the determination unit 15 is the highest among a plurality of candidates for a product recognized by the product recognizing unit 13 as a result of recognition of one product area image in association with the one product area image. Accordingly, a result of recognition of a product for one product area image can be easily corrected.

In addition, in a case in which validity of recognition of a product recognized for one product area image is less than a predetermined degree, the display unit 16 may display the product recognized for a product area image adjacent to the one product area image in an image of product display shelves as a candidate for a product represented by the one product area image.

More specifically, the product recognizing unit 13 performs recognition of a product for one product area image area and performs recognition of a product for a product area image adjacent to the one product area image. Then, the determination unit 15 assumes that the product recognized for the adjacent product area image is the product recognized for the one product area image and determines validity of the assumed recognition. Then, the display unit 16 may display information of the product recognized for the adjacent product area image as a candidate for the product represented by the one product area image together with information relating to the validity thereof.

For example, in a case in which the validity of recognition of the product recognized for the one product area image is less than a predetermined degree and in a case in which the product represented by the one product area image is not included in a result of recognition of the one product area image, candidates for a product that has a possibility of being the product represented by the one product area image can be presented to the user.

The correction unit 17 corrects a first product recognized as the product represented by the one product area image by the product recognizing unit 13 on the basis of the information relating to validity determined by the determination unit 15.

For example, in a case in which it is determined by the determination unit 15 that a product other than the first product recognized by the product recognizing unit 13 has the highest validity as a result of recognition of the one product area image, the correction unit 17 corrects the result of recognition of a product represented by the one product area image to the product determined to have the highest validity. More specifically, for example, in a case in which a plurality of candidates for a product represented by one product area image are recognized by the product recognizing unit 13 for the one product area image, and validity of recognition is determined by the determination unit 15 for each of a plurality of products output as a result of recognition of the one product area image, the correction unit 17 corrects the result of recognition of a product represented by the one product area image to a product having the highest validity of recognition.

In addition, as described above, in a case in which a correcting input is made by the user in accordance with display of information relating to validity of recognition of the one product area image as the first product using the display unit 16, the correction unit 17 may correct the result of recognition of a product represented by the one product area image to an input product.

The generation unit 18 generates planogram information that is information of arrangement of products arranged on product display shelves. More specifically, the generation unit 18 generates planogram information on the basis of a positional relation between the position of a shelf board acquired from an image of the product display shelf and the position of a product area image detected by the detection unit and information of a product represented by the product area image recognized by the product recognizing unit 13. One example of the planogram information is illustrated in FIG. 7. In this embodiment, the generation unit 18 generates planogram information on which a correction of the result of recognition of a product area image using the correction unit 17 is reflected. The generation unit 18 can output the generated planogram information to a predetermined storage means. In addition, the generation unit 18 may display the generated planogram information on the display 22.

Variations of information that is further used for determining validity of recognition of a product for one product area image using the determination unit 15 will be described below.

The determination unit 15 may determine validity by further referring to color information representing a difference between information relating to a color of one product area image and information relating to a color of another product area image. In other words, the determination unit 15 can determine validity by further using color information as relevancy information.

More specifically, the determination unit 15 generates a color histogram of one product area image and a color histogram of another product area image (a product area image that is adjacent or close to the one product area image or the like) and calculates a similarity between the generated color histograms (information representing a difference). The similarity, for example, is realized by calculation of a so-called cosine distance or the like, and a calculation method thereof is not particularly limited, and any known technique may be used.

The determination unit 15 may determine validity of recognition of a product of one product area image using a validity determiner further using the similarity between the color histograms as feature quantity. The validity determiner used in this case can be acquired through machine learning using the similarity between the color histograms as a feature quantity. In addition, a similarity between color histograms between different product area images may be further used as a feature quantity. In addition, in the generation of color histograms, appropriate subtractive color processing may be performed in accordance with conditions such as a processing load and the like.

The determination unit 15 may determine validity by further referring to information relating to a distance between one product area image and another product area image in an image of product display shelves. In other words, the determination unit 15 may determine validity by further using information relating to a distance between one product area image and another product area image as relevancy information. More specifically, the determination unit 15 calculates a distance between one product area image and another product area image (a product area image that is adjacent or close to the one product area image or the like). The distance between the product area images, for example, may be represented in the number of pixels in an image of product display shelves or the number of faces.

The determination unit 15 may determine validity of recognition of a product of one product area image using a validity determiner further using a distance between the one product area image and another product area image as a feature quantity. The validity determiner used in this case is acquired through machine learning having a distance between product area images as a feature quantity. In addition, a distance between other product area images may be further used as a feature quantity.

In addition, the determination unit 15 may use a recognition score representing the accuracy of recognition of a product for a product area image that is output by the product recognizing unit 13 for determining the validity. In other words, the determination unit 15 may determine the validity by further referring to recognition scores relating to recognition of products for one product area image and another product area image as relevancy information. More specifically, the determination unit 15 acquires recognition scores for one product area image and another product area image (a product image area adjacent or close to the one product area image or the like). Then, the determination unit 15 may determine validity of recognition of a product of one product area image using a validity determiner by further using a recognition score relating to each product area image as a feature quantity. The validity determiner used in this case is acquired through machine learning having a recognition score relating to the product area image as a feature quantity.

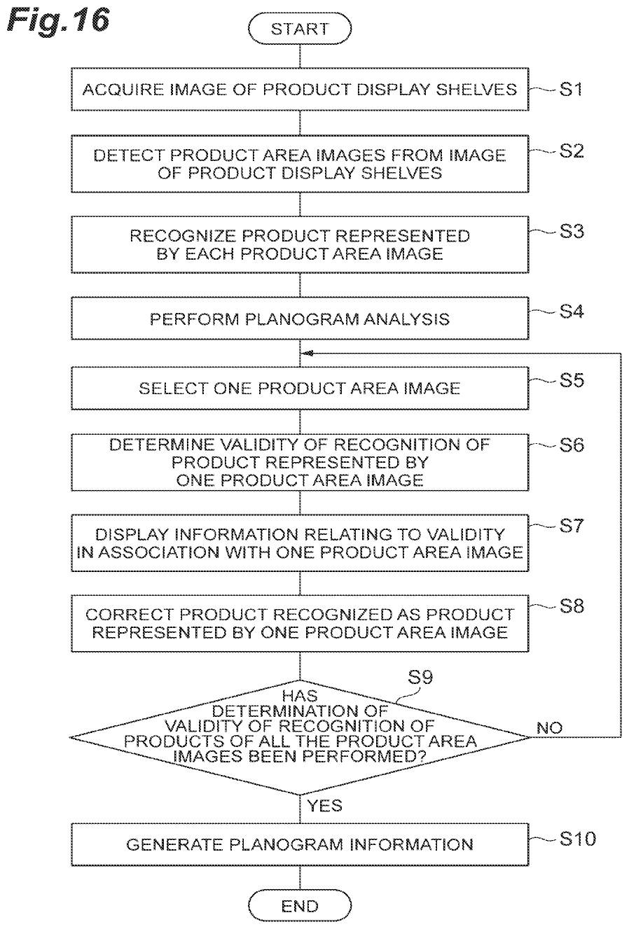

Next, a planogram information generating method used in the planogram information generating device 10 will be described with reference to FIG. 16. FIG. 10 is a flowchart illustrating processing details of the planogram information generating method according to this embodiment.

In Step S1, the image acquiring unit 11 acquires an image of product display shelves, which is imaged by the camera 21, on which a plurality of products are arranged. In the subsequent Step S2, the detection unit 12 detects product area images representing products from the image of product display shelves acquired by the image acquiring unit 11 in Step S1.

Next, in Step S3, the product recognizing unit 13 recognizes a product represented by each product area image detected by the detection unit 12 in Step S2 on the basis of information relating to images of products stored in advance.

In Step S4, the planogram analyzing unit 14 acquires planogram data that is information relating to arrangement of products on each of product display shelves on the basis of a result of recognition of products using the product recognizing unit 13 in Step S3 and a positional relation of product area images in the image of product display shelves. In addition, the process of Step S4 is not an essential process in the planogram information generating method according to this embodiment.

In Step S5, the determination unit 15 selects one product area image among a plurality of product area images recognized in Step S3. In Step S6, the validity of recognition of a product represented by one product area image is determined.

In Step S7, the display unit 16 displays information relating to the validity of recognition of a product for one product area image, which has been determined by the determination unit 15 in Step S6, on the display 22 in association with the one product area image. In addition, the process of Step S7 is not an essential process in the planogram information generating method according to this embodiment.

In Step S8, the correction unit 17 corrects the product recognized by the product recognizing unit 13 as a product represented by one product area image in Step S3 on the basis of the information relating to the validity determined by the determination unit 15 in Step S6.

In Step S9, the determination unit 15 determines whether or not determination of validity of recognition of products of all the product area images has been performed. In a case in which it is determined that determination of validity of all the product area images has been performed, the process proceeds to Step S10. On the other hand, in a case in which it is determined that determination of validity of all the product area images has not been performed, the processes of Steps S5 to S8 are repeated. In addition, in the planogram information generating method according to this embodiment, determination of validity for all the product area images and correction for a recognized product are not essential, and, when the processes of Steps S5 to S8 for some product area images are completed, the processing sequence may proceed to Step S10.

In Step S10, the generation unit 18 generates planogram information. More specifically, the generation unit 18 generates planogram information on which correction for a product recognized in Step S8 is reflected.

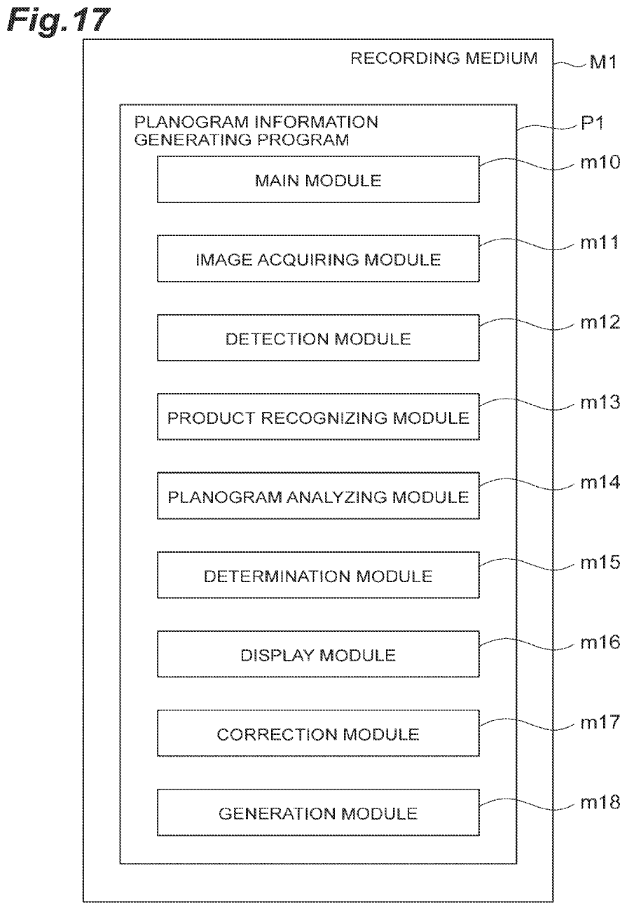

Next, a planogram information generating program for causing a computer to function as the planogram information generating device 10 according to this embodiment will be described. FIG. 17 is a diagram illustrating the configuration of the planogram information generating program P1.

The planogram information generating program P1 is configured to include a main module m10 that performs overall control of a planogram information generating process in the planogram information generating device 10, an image acquiring module m11, the detection module m12, the product recognizing module m13, a planogram analyzing module m14, a determination module m15, a display module m16, a correction module m17, and a generation module m18. Functions for the image acquiring unit 11, the detection unit 12, the product recognizing unit 13, the planogram analyzing unit 14, the determination unit 15, the display unit 16, the correction unit 17, and the generation unit 18 of the planogram information generating device 10 are realized by the modules m11 to m18. In addition, the planogram information generating program P1 may be in the form of being transmitted through a transmission medium such as a communication line or, as illustrated in FIG. 17, may be in the form of being stored on a recording medium M1.

In the planogram information generating device 10, the planogram information generating method, and the planograin information generating program P1 according to this embodiment described above, in consideration of a feature in that one product arranged on a product display shelf has relevancy with another product adjacent to the one product and another product arranged within a predetermined distance from the one product, product area images are detected from an image of product display shelves, a product represented by each of the product area images is recognized, and validity of recognition of one product area image as a first product is determined on the basis of relevancy information between the first product recognized as a product represented by the one product area image and a second product recognized as a product represented by another product area image. Then, the first product recognized as a product represented by the one product area image is corrected on the basis of information relating to the determined validity. In this way, a result of recognition of a product for a product area image is easily corrected, and the accuracy of the recognition can be improved.

In addition, in a planogram information generating device according to another embodiment, the other product area images may include product area images adjacent to the one product area image in the image of the product display shelves.

Products adjacent to each other on a product display shelf tend to have strong relevance in such attributes and the like. According to the embodiment described above, information representing relevance between a product represented by one product area image and products represented by product area images adjacent to the one product area image is included in the relevancy information, and accordingly, the accuracy of determination of the validity of recognition of the product for one product area image is improved.

In addition, in a planogram information generating device according to another embodiment, the other product area images may include product area images present within a predetermined distance from the one product area image in the image of the product display shelves.

Products arranged to be close to each other on a product display shelf tends to have relevance in such attributes and the like. According to the embodiment described above, information representing relevance between a product represented by one product area image and products represented by product area images present within a predetermined distance from the one product area image is included in the relevancy information, and accordingly, the validity of recognition of a product for one product area image is appropriately determined.

In addition, a planogram information generating device according to another embodiment further includes a planogram analyzing unit that acquires information relating to arrangement of products on each shelf of the product display shelves on the basis of a result of recognition of products using the product recognizing unit and a positional relation of the product area images in the image of the product display shelves, and the other product area images may be product area images having a predetermined positional relation with the one product area image among product area images of products arranged on each shelf of the product display shelves.

According to the embodiment described above, on the basis of the information relating to the arrangement of products on each shelf of product display shelves, information representing relevance between a product represented by one product area image and products represented by product area images having a predetermined positional relation with the one product area image is included in the relevancy information, and accordingly, the validity of recognition of a product for one product area image is appropriately performed.

In addition, in a planogram information generating device according to another embodiment, the relevancy information may be information representing a degree of coincidence between an attribute of the first product and an attribute of the second product.

According to the embodiment described above, the degree of coincidence between an attribute of the first product and an attribute of the second product is employed as relevancy information, and accordingly, the relevance between the first product and the second product is appropriately represented using the relevancy information.

In addition, a planogram information generating device according to another embodiment may further include a display unit that displays the information relating to the validity determined by the determination unit.

According to the embodiment described above, by referring to the information relating to the displayed validity, a user can easily check and correct a result of recognition of a product for one product area image.

In addition, in a planogram information generating device according to another embodiment, in a case in which the validity of recognition of the one product area image determined by the determination unit is less than a predetermined degree, the display unit may display information relating to the validity in a predetermined form in association with the one product area image.

According to the embodiment described above, a user can be allowed to recognize a product area image having low validity of the result of product recognition.

In addition, in a planogram information generating device according to another embodiment, the product recognizing unit recognizes a plurality of candidates for a product represented by the one product area image for the one product area image, the determination unit determines validity in a case in which each of the plurality of candidates for the product is recognized as the first product, and the display unit may display at least one candidate for the product among the plurality of candidates for the product and information relating to validity of the candidate in association with the one product area image.

According to the embodiment described above, a more valid candidate for a product can be presented as a product represented by the one product area image, and accordingly, a result of recognition of a product for the one product area image can be easily checked and corrected.

In addition, in a planogram information generating device according to another embodiment, in a case in which the validity of recognition of the one product area image determined by the determination unit is less than a predetermined degree, the display unit may display the second products as candidates for a product represented by the one product area image.

According to the embodiment described above, in consideration of high relevancy between a product represented by one product area image and products represented by other product area images, the second products recognized as products represented by other product area images are presented as candidates for a product represented by the one product area image. Accordingly, products having a high possibility of being a product represented by the one product area image are presented, and accordingly, a result of recognition of a product for the one product area image can be easily corrected.

In addition, in a planogram information generating device according to another embodiment, the product recognizing unit recognizes a plurality of candidates for the product represented by the one product area image for the one product area image, the determination unit determines validity in a case in which each of the plurality of candidates for the product is set as the first product, and display unit may display a candidate for the product having the highest validity among the plurality of candidates for the product in association with the one product area image as a result of recognition of the one product area image.

According to the embodiment described above, the most valid candidate for a product as a product represented by one product area image can be presented, and accordingly, a result of recognition of the product for the one product area image can be easily corrected.

In addition, in a planogram information generating device according to another embodiment, the correction unit may correct the first product recognized as the product represented by the one product area image using the product recognizing unit on the basis of a correction input that is input by a user in accordance with the information relating to the validity displayed by the display unit.

According to the embodiment described above, the result of recognition of a product is corrected on the basis of information input by a user who has recognized the information relating to validity of recognition of the product for the product area image, and accordingly, the result of recognition of the product for the one product area image can be corrected reliably and appropriately.

In addition, in a planogram information generating device according to another embodiment, the determination unit may determine validity by further referring to color information representing a difference between information relating to a color of one product area image and information relating to colors of other product area images.

According to the embodiment described above, by considering that there is a high possibility that the difference between the color of one product area image and colors of other product area images is small due to strong relevancy between a product represented by the one product area image and products represented by other product area images, the validity of recognition of the product for the one product area image is determined by further referring to the difference between the information relating to the color of the one product area image and the information relating to the colors of other product area images. Accordingly, the accuracy of determination of the validity is improved.

In addition, in a planogram information generating device according to another embodiment, the determination unit may determine the validity by further referring to information relating to a distance between one product area image and other product area images in the image of the product display shelf.

According to the embodiment described above, by considering that a degree of relevancy between a product represented by one product area image and products represented by other product area images depends on a distance between the product area images, the validity of recognition of the product for one product area image is determined by further referring to information relating to a distance between the product area images. Accordingly, the accuracy of determination of the validity is improved.

In addition, in the planogram information generating device according to another embodiment, the product recognizing unit outputs a recognition score representing accuracy of recognition of a product for a product area image, and the determination unit may determine the validity by further referring to recognition scores relating to recognition of products for one product area image and other product area images.

According to the embodiment described above, the validity of recognition of a product relating to one product area image is determined using a recognition score representing the accuracy of recognition of a product for a product area image. Accordingly, the accuracy of determination of the validity is improved.

As above, while the present invention has been described in detail, it is apparent to a person skilled in the art that the present invention is not limited to the embodiments described in this specification. The present invention may be modified or changed without departing from the concept and the scope of the present invention set in accordance with the claims. Thus, the description presented in this specification is for the purpose of exemplary description and does not have any limited meaning for the present invention.

Each aspect/embodiment described in the present disclosure may be applied to long term evolution (LTE), LTE-advanced (LTE-A), Super 3G, IMT-advanced, 4G, 5G, future ratio access (FRA), W-CDMA (Registered trademark), GSM (registered trademark), CDMA 2000, ultra mobile broadband (UMB), IEEE 802.11 (Wi-Fi), IEEE 802.16 (WiMAX), IEEE 802.20, ultra-wideband (UWB), Bluetooth (registered trademark), a system using another appropriate system and/or a next generation system extended based on these.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

Information and the like may be output from an upper layer (or a lower layer) to a lower layer (or an upper layer). The information and the like may be input and output through a plurality of network nodes.

The input/output information and the like may be stored in a specific place (for example, a memory) or managed using a management table. The input/output information and the like may be overwritten, updated, or additionally written. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to be performed explicitly and may be performed implicitly (for example, a notification of the predetermined information is not performed).

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, and the like may be transmitted and received via a transmission medium. For example, in a case in which software is transmitted from a website, a server, or any other remote source using wiring technologies such as a coaxial cable, an optical fiber cable, a twisted pair, a digital subscriber line (DSL) and the like and/or radio technologies such infrared rays, radio waves, and microwaves, and the like, such wiring technologies and/or radio technologies are included in the definition of the transmission medium.

Information, a signal, and the like described in the present disclosure may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, a term described in the present disclosure and/or a term that is necessary for understanding the present disclosure may be substituted with terms having the same meaning or a meaning similar thereto.

Terms “system” and “network” used in the present disclosure are compatibly used.

In addition, information, a parameter, and the like described in the present disclosure may be represented using absolute values, relative values from predetermined values, or other corresponding information.

Description of “on the basis of” used in the present invention does not mean “only on the basis of” unless otherwise mentioned. In other words, description of “on the basis of” means both “only on the basis of and at least on the basis of.”

In the present disclosure, in a case in which names such as “first,” “second,” and the like is used, referring to each element does not generally limit the amount or the order of such an element. Such names may be used in the present disclosure as a convenient way for distinguishing two or more elements from each other. Accordingly, referring to the first and second elements does not mean that only the two elements are employed therein or the first element precedes the second element in a certain form.

As long as “include,” “including,” and modifications thereof are used in the present disclosure or the claims, such terms are intended to be inclusive like a term “comprising.” In addition, a term “or” used in the present disclosure or the claims is intended to be not an exclusive logical sum.

In the present disclosure, other than a case in which clearly only one device is present in a context or technically, a device includes a plurality of devices.

In the entirety of the present disclosure, unless a singular form is represented clearly from the context, plural forms are included.

### REFERENCE SIGNS LIST

1 planogram information generating system
10 planogram information generating device
11 image acquiring unit
12 detection unit
13 product recognizing unit
14 planogram analyzing unit
15 determination unit
16 display unit
17 correction unit
18 generation unit
20 imaging device/display device
21 camera
22 display
30 product data storing unit
31 product image data
32 product master
40 learning model storing unit
50 recognition result storing unit
M1 recording medium
m10 main module
m11 image acquiring module
m12 detection module
m13 product recognizing module
m14 planogram analyzing module
m15 determination module
m16 display module
m17 correction module
m18 generation module
P1 planogram information generating program

1: A planogram information generating device that generates planogram information that is arrangement information of products arranged on product display shelves, the planogram information generating device comprising circuitry configured to:
acquire an image acquired by imaging product display shelves on which a plurality of products are arranged;
detect product area images representing the products from the image acquired by the circuitry;
recognize products represented by the product area images detected by the circuitry on the basis of information relating to images of products stored in advance;
determine validity of recognition of one product area image as a first product on the basis of relevancy information between the first product recognized as a product represented by the one product area image and one or more second products recognized as products represented by one or more other product area images other than the one product area image; and
correct the first product recognized as the product represented by the one product area image by the circuitry on the basis of information relating to the validity determined by the circuitry.

2: The planogram information generating device according to claim 1, wherein the other product area images include product area images adjacent to the one product area image in the image of the product display shelves.

3: The planogram information generating device according to claim 1, wherein the other product area images include product area images present within a predetermined distance from the one product area image in the image of the product display shelves.

4: The planogram information generating device according to claim 1, wherein the circuitry is further configured to acquire information relating to arrangement of products on each shelf of the product display shelves on the basis of a result of recognition of products and a positional relation of the product area images in the image of the product display shelves,
wherein the other product area images are product area images having a predetermined positional relation with the one product area image among product area images of products arranged on each shelf of the product display shelves.

5: The planogram information generating device according to claim 1, wherein the relevancy information is information representing a degree of coincidence between an attribute of the first product and an attribute of the second product.

6. The planogram information generating device according to claim 1, wherein the circuitry is further configured to display the information relating to the validity determined by the circuitry.

7: The planogram information generating device according to claim 6,
wherein the circuitry recognizes a plurality of candidates for a product represented by the one product area image for the one product area image,
wherein the circuitry determines validity in a case in which each of the plurality of candidates for the product is recognized as the first product, and
wherein the circuitry displays at least one candidate for the product among the plurality of candidates for the product and information relating to invalidity of the candidate in association with the one product area image.

8: The planogram information generating device according to claim 6,
wherein the circuitry recognizes a plurality of candidates for the product represented by the one product area image for the one product area image,
wherein the circuitry determines validity in a case in which each of the plurality of candidates for the product is set as the first product, and
wherein the circuitry displays a candidate for the product having the highest validity among the plurality of candidates for the product in association with the one product area image as a result of recognition of the one product area image.

9: The planogram information generating device according to claim 6, wherein the circuitry corrects the first product recognized as the product represented by the one product area image by the circuitry on the basis of a correction input that is input by a user in accordance with the information relating to the validity displayed by the circuitry.

10. (canceled)

11: The planogram information generating device according to claim 2, wherein the other product area images include product area images present within a predetermined distance from the one product area image in the image of the product display shelves.
